(19) United States
(12) Patent Application Publication
(10) Pub. No.: US 2016/0070092 A1
(43) Pub. Date: Mar. 10, 2016

(54) METHOD AND DEVICE FOR FLUORESCENT IMAGING OF SINGLE NANO-PARTICLES AND VIRUSES

(71) Applicant: THE REGENTS OF THE UNIVERSITY OF CALIFORNIA, Oakland, CA (US)

(72) Inventors: Aydogan Ozcan, Los Angeles, CA (US); Qingshan Wei, Los Angeles, CA (US)

(73) Assignee: THE REGENTS OF THE UNIVERSITY OF CALIFORNIA, Oakland, CA (US)

(21) Appl. No.: 14/845,142

(22) Filed: Sep. 3, 2015

Related U.S. Application Data
(60) Provisional application No. 62/045,812, filed on Sep. 4, 2014.

(51) Int. Cl. G02B 21/36; G02B 21/34; H04N 7/18; G02B 7/00; G02B 21/00; H04N 5/225; G02B 21/26; G02B 21/16

(52) U.S. Cl. CPC G02B 21/362; G02B 21/26; G02B 21/34; G02B 21/361; G02B 21/16; G02B 7/006; G02B 21/0008; H04N 5/2256; H04N 7/183

(57) ABSTRACT

A field-portable fluorescence imaging platform is disclosed that is installed on mobile communications device for imaging of individual nanoparticles or microparticles such as viruses, bacterial, and the like using a light-weight and compact opto-mechanical attachment or housing configured to be removably secured to the mobile communication device. The housing includes a sample holder configured to hold a sample along with a light source and a lens or lens system that is positioned generally opposite the lens in the mobile communication device. An optical filter is disposed in the housing and is interposed between the lens of the housing and the lens of the mobile communication device. A z-adjust stage is disposed in the housing and coupled to the sample holder, the z-adjust stage is configured to adjust the position of the sample holder in a z direction along an optical path passing through the lenses and onto an image sensor contained in the mobile communication device.

### RELATED APPLICATION

This application claims priority to U.S. Provisional Patent Application Nos. 62/045,812 filed on Sep. 4, 2014. Priority is claimed pursuant to 35 U.S.C. §119. The above-noted patent application is incorporated by reference as if set forth fully herein.

### STATEMENT REGARDING FEDERALLY SPONSORED RESEARCH AND DEVELOPMENT

This invention was made with Government support under W911NF-11-1-0303, W911NF-13-1-0197, awarded by the U.S. Army, Army Research Office, N00014-12-1-0307, awarded by the U.S. Navy, Office of Naval Research, OD006427, TR000124, awarded by the National Institutes of Health, 0954482, awarded by the National Science Foundation. The Government has certain rights in the invention.

### TECHNICAL FIELD

The technical field generally relates methods and devices used in connection with imaging small particles and viruses using a mobile communication device such as a mobile phone.

### BACKGROUND

Optical imaging of single nanoparticles has become increasingly important for various fields in for example nanoscience and biomedicine. With recent advances in light microscopy techniques, individual nanoparticles as small as a few nanometers have been visualized by a number of imaging methods, such as photothermal imaging, interferometric and darkfield scattering microscopy, among others. However, conventional imaging methods used for the detection of isolated sub-wavelength particles all rely on relatively sophisticated and expensive microscopy systems, which also involve high numerical aperture (NA) objective lenses and other bulky optical components, with a small imaging field-of-view (FOV) of e.g., <0.2 mm². More recently, a lens-free holographic imaging technique has been demonstrated which can detect sub-100 nm particles across a large FOV of >20 mm² which uses biocompatible wetting films to self-assemble aspheric liquid nanolenses around individual nanoparticles. See Mudanyali et al., Wide-field optical detection of nanoparticles using on-chip microscopy and self-assembled nanolenses, Nature Photonics 7, 247-254 (2013). However, this approach relies on bright-field coherent imaging and is not applicable to fluorescent specimen due to the lack of sufficient spatial and temporal coherence.

### SUMMARY

In one embodiment, an imaging device includes a mobile communication device (e.g., a mobile phone) having a camera therein comprising an image sensor and a first lens contained in the mobile communication device. The imaging device includes a housing or opto-mechanical attachment configured to be removably secured to the mobile communication device and contains the optical components used to image nanometer or micrometer-sized particles. The housing includes a sample holder configured to hold a sample and aligned along an optical path intersecting with the image sensor and the first lens. A second lens (or multiple lenses making up a second lens system) is disposed in the housing and aligned along the optical path. The housing includes a light source disposed therein and oriented to illuminate the sample holder at an angle relative thereto. By illuminating at an angle, this reduces the amount of light from the excitation source (either direct light or indirect scattering) from reaching the image sensor. To this end, an optical filter is disposed in the housing and aligned along the optical path, the optical filter interposed between the first lens and the second lens. The optical filter filters out scattered excitation light yet permits the passage of fluorescent light. The housing further includes a z-adjust stage disposed therein and coupled to the sample holder, the z-adjust stage configured to adjust the position of the sample holder in a z direction along the optical path for focusing purposes.

In another embodiment, a method of obtaining fluorescent images of a sample using the imaging device described above includes loading the sample holder with a sample containing nanometer or micrometer-sized objects and a fluorescent label; illuminating the sample with the light source to cause the fluorescent label to emit fluorescent light; and imaging the sample with the camera.

The housing acts as a compact and light-weight opto-mechanical attachment that can be secured to an existing camera module of a mobile phone for detection of individual fluorescent nanoparticles and viruses. This field-portable fluorescent imaging device involves, in one embodiment, a compact laser diode based on excitation at 450 nm that illuminates the sample plane at a high incidence angle, a long-pass (LP) thin-film interference filter, an external low NA lens (NA less than about 0.4) and a coarse mechanical translation stage for focusing and depth adjustment. The oblique illumination light on the sample plane is by and large missed by the low NA of the external collection lens, and only the scattered excitation beam needs to be blocked through the LP filter, creating a very efficient background rejection mechanism that is necessary to isolate the extremely weak fluorescent signal arising from individual nanoparticles or viruses. The same low NA imaging system is also useful for reducing the alignment sensitivity to depth of field, such that a coarse mechanical translation stage would be sufficient to focus the mobile phone-based imaging device to the sample plane even in field conditions.

The imaging performance of the mobile phone-based fluorescent microscopy platform was tested using 100 nm fluorescent particles as well as labeled human cytomegaloviruses (HCMV); a virus type that is known to cause significant morbidity and mortality in immunocompromised patients. To make sure that indeed single nanoparticles or viruses are detected, each sample was also imaged by scanning electron microscopy (SEM) to validate the mobile phone-based imaging results. These results demonstrate that a mobile phone-based field-portable imaging platform has been able to detect single viruses or deeply sub-wavelength objects. The imaging performance reached through this work would provide new opportunities for the practice of nanotechnology in telemedicine and point-of-care (POC) applications, among others.

### BRIEF DESCRIPTION OF THE DRAWINGS

FIG. 1A illustrates a front view of an imaging device according to one embodiment. The display or screen of the mobile communication device is illustrated showing an image of nanometer-sized particles that have been imaged.

FIG. 1B illustrates a side view of the imaging device of FIG. 1A.

FIG. 1C illustrates a perspective view of the imaging device of FIG. 1A. A portion of the housing is removed to illustrate the internal optical components of the imaging device.

FIG. 1D is another perspective view of the imaging device of FIG. 1A. The moveable sample tray and the moveable filter tray are illustrated in the “open” configuration.

FIG. 1E illustrates a light source obliquely angled relative to the sample holder at an angle α.

FIG. 1F illustrates a schematic representation of optical components of the housing and the mobile communication device as well as a ray diagram showing incident excitation light from the light sources, scattered light (solid lines), and fluorescent light (dashed lines).

FIG. 2 illustrates the transmission spectrum of the long-pass filter (2-mm thick 500 nm long-pass thin-film interference filter (FF01-500/LP-23.3-D, Semrock) overlaid with the spectrum of the laser diode as measured by Ocean Optics HR2000+ spectrometer.

FIG. 3A illustrates an image obtained using the mobile phone-based imaging device to image 100 nm fluorescent particles over an area of 0.6 mm×0.6 mm.

FIG. 3B illustrates an enlarged image of ROI “b” of FIG. 3A.

FIG. 3C illustrates an enlarged image of ROI “c” of FIG. 3A.

FIG. 3D illustrates an SEM image of the region “d” of FIG. 3B.

FIG. 3E illustrates an SEM image of the region “e” of FIG. 3C.

FIG. 3F illustrates a high magnification image of region “f” of FIG. 3D.

FIG. 3G illustrates a high magnification image of region “g” of FIG. 3D.

FIG. 3H illustrates a high magnification image of region “h” of FIG. 3E.

FIG. 4 illustrates mobile phone-based imaging of PS beads with various sizes. 1^{st} row: mobile phone imaging device images w/500 nm LP filter; 2^{nd} row: mobile phone imaging device images w/o 500 nm LP filter; 3^{rd} row: conventional fluorescence images obtained with a 60× objective; 4^{th} row: conventional transmission images obtained with a 60× objective. Arrows indicate non-fluorescent particles. Note that in these experiments 1-μm fluorescent particles were mixed with 1-μm non-fluorescent ones, and 500 nm, 250 nm, and 100 nm fluorescent particles were mixed with 500 nm non-fluorescent particles. As illustrated in the far-right column, the scattering signal for 100 nm fluorescent particles is much weaker than the scattering signal of 500 nm non-fluorescent particles, as a result of which without the LP filter the signatures of 100 nm fluorescent particles remain hidden compared to 500 nm non-fluorescent particles. However, with the insertion of the LP filter, the scattering signatures are eliminated and only the fluorescent nanometer sized particles are detected.

FIG. 5A illustrates an image obtained using the mobile phone-based imaging device to image 100 nm PS particles.

FIG. 5B is a photon counting map that corresponds to the dashed area in FIG. 5A, measured using a confocal laser scanning microscope. Note that the excitation conditions in FIG. 5A and FIG. 5B are different, which means the absolute photon count per second (cps) per particle might exhibit differences between the two images.

FIG. 5C is a high magnification SEM image of the same area of the photon counting map shown in FIG. 5B.

FIG. 5D is a high magnification SEM image of nanoparticle clusters identified at location “d” in FIG. 5B.

FIG. 5E is a high magnification SEM image of a single nanoparticle identified at location “e” in FIG. 5B.

FIG. 5F is a high magnification SEM image of a single nanoparticle identified at location “f” in FIG. 5B.

FIG. 5G is a high magnification SEM image of a single nanoparticle identified at location “g” in FIG. 5B.

FIG. 5H is a high magnification SEM image of a single nanoparticle identified at location “h” in FIG. 5B.

FIG. 5I is a high magnification SEM image of nanoparticle clusters identified at location “i” in FIG. 5B.

FIG. 5J is a graph showing the correlation of the fluorescent photon counts per second (pcs) per object as a function of the cluster size.

FIG. 5K is a graph of fluorescent photon count distribution of single 100 nm particles (measured using 60 nanoparticles).

FIG. 6A illustrates a transmission image of a resolution test target captured by a conventional microscope with a 10× objective lens (0.25 NA).

FIG. 6B illustrates the same test target of FIG. 6A that was imaged by the fluorescent imaging device described herein.

FIG. 6C is the deconvolved image from the mobile phone-based imaging device. Isolated 100 nm fluorescent particles were used to estimate the point spread function of the device.

FIG. 6D illustrates the line intensity profiles corresponding to the lines “d” in FIG. 6B and FIG. 6C.

FIG. 6E illustrates the line intensity profiles corresponding to the lines “e” in FIG. 6B and FIG. 6C.

FIG. 6F illustrates the line intensity profiles corresponding to the lines “f” in FIG. 6B and FIG. 6C.

FIG. 6G illustrates the line intensity profiles corresponding to the lines “g” in FIG. 6B and FIG. 6C.

FIG. 6H illustrates the line intensity profiles corresponding to the lines “h” in FIG. 6B and FIG. 6C.

FIG. 6I illustrates the line intensity profiles corresponding to the lines “d” in FIG. 6B and FIG. 6C.

FIG. 7A illustrates a fluorescence image of Alexa Fluor® 488-labeled HCMV particles obtained using the fluorescent imaging device described herein. 2 μm red florescent beads were used as location markers for SEM comparison images.

FIG. 7B illustrates a SEM image of the “b” region in FIG. 7A.

FIG. 7C illustrates a SEM image of the “c” region in FIG. 7A.

FIG. 7D is an enlarged view of the “d” region in FIGS. 7A and 7B.

FIG. 7E is a high magnification SEM image of an individual HCMV particle highlighted by region “e” of FIG. 7C. The same isolated viral particles are also highlighted within the inset fluorescence images of FIG. 7A.

FIG. 7F is a high magnification SEM image of an individual HCMV particle highlighted by region “f” of FIG. 7C. The same isolated viral particles are also highlighted within the inset fluorescence images of FIG. 7A.

FIG. 7G is a high magnification SEM image of an individual HCMV particle highlighted by region “g” of FIG. 7D. The same isolated viral particles are also highlighted within the inset fluorescence images of FIG. 7A.

FIG. 7H is a high magnification SEM image of an individual HCMV particle highlighted by region “h” of FIG. 7D. The same isolated viral particles are also highlighted within the inset fluorescence images of FIG. 7A.

FIG. 8A is a mobile phone fluorescence image of labeled HCMV particles at an incubation concentration of 10⁷ PFU/mL.

FIG. 8B is a photon-counting map corresponding to the dashed area “b” in FIG. 8A, measured using a confocal laser scanning microscope. Note that the excitation conditions in FIG. 8A and FIG. 8B are different, which means the absolute photon count per second (cps) per particle might exhibit differences between the two images.

FIG. 8C is a distribution of the intensity of the labeled HCMV particles in the cellphone fluorescent images.

FIG. 8D is a mobile phone-based virus density measurements (counts/mm²) plotted against different virus incubation concentrations (10³, 10⁴, 10⁵, 10⁶, and 10⁷ PFU/mL). Three independent measurements for each concentration were performed.

### DETAILED DESCRIPTION OF THE ILLUSTRATED EMBODIMENTS

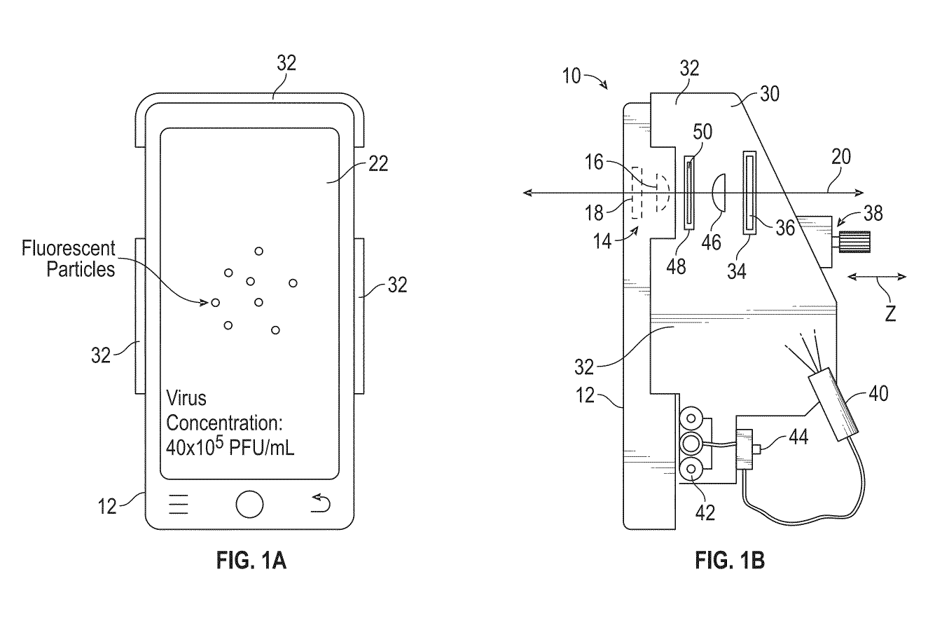

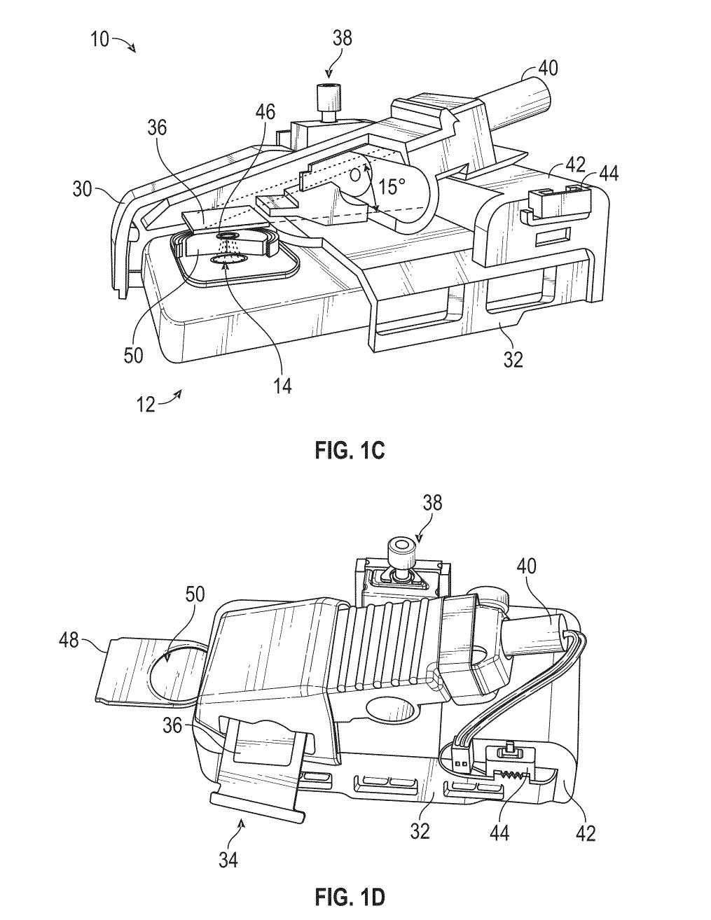

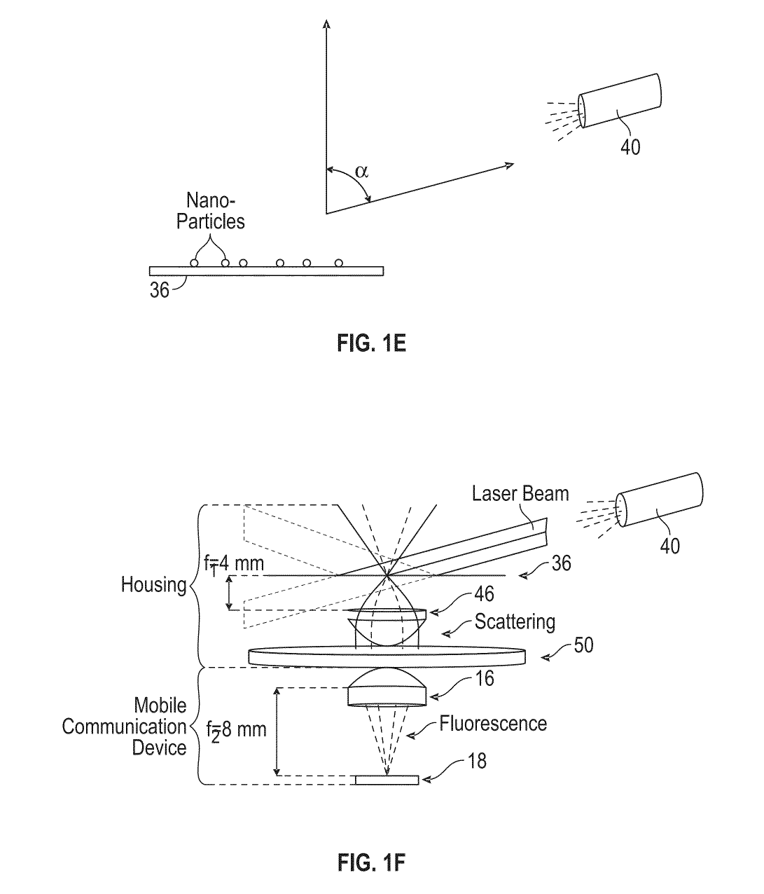

FIGS. 1A-1D illustrates an imaging device 10 that is used for the fluorescent imaging of nanometer-sized objects such as particles, bacteria, and viruses. The imaging device 10 utilizes a mobile communication device 12 such as a mobile phone (e.g., SMARTPHONE) although other devices such as tablets and personal digital assistant (e.g., PDAs) and the like may also be used. The mobile communication device 12 has the ability to acquire images using a camera 14 that is built into the mobile communication device 12. The camera 14 includes an internal lens 16 (or multiple lenses) as well as an image sensor 18 (e.g., CCD or CMOS image sensor) in the mobile communication device 12. An optical path 20 is defined along a path formed between the image sensor 18 and the internal lens 16. The optical path 20 is thus generally oriented perpendicular to the image sensor 18 and intersects with the internal lens 16 of the mobile communication device 12. Typically, the mobile communication device 12 includes a display 22 (FIG. 1A) that is on one side of the device 12. Often, the camera 14 is located on a side of the mobile communication device 12 that is opposite the display 22 although in some embodiments, the camera 14 may be on the same side as the display 22.

The imaging device 10 also includes a housing 30 that is dimensioned and otherwise designed to be removably secured to a side of the mobile communication device 12 that contains the camera 14. The housing 30 acts as an opto-mechanical attachment that can be selectively attached or detached to the mobile communication device 12 to perform fluorescent imaging of a sample. The housing 30 holds the loaded sample as well as the non-mobile phone optical components used in the fluorescent imaging device 10. The housing 30, when attached, also prevents ambient light from entering the optical path 20 and flooding the image sensor 18. In this regard, the housing 30 ensures that the light that reaches the image sensor 18 is the fluorescent light emitted from the fluorescently labeled or tagged nanometer sized particles. The housing 30 includes one or more attachment points 32 (best seen in FIGS. 1A, 1B, and 1C) that are used to secure the housing 30 to the mobile communication device 12. The attachment points 32 may include flanges, clips, tabs, slots, or the like. The attachment points 32 may be made from a flexible or semi-rigid construction so that the entire housing 30 can be secured to or removed from the mobile communication device 12 as needed. For example, the housing 30 may be made from polymer components making the same lightweight. The housing 30 may have a number of sizes and configurations such that the housing 30 may be secured to different makes and models of mobile communication devices 12. The housing 30 may even have adjustable attachment points 32 so that the housing 30 can accommodate different sized/shaped mobile communication devices 12. The housing 30 is compact in size and has low weight (e.g., less than a few hundred grams) making the same ideal for hand-held use in the field.

Referring to FIG. 1D, the housing 30 includes a moveable sample tray 34 that can be moved between an “open” state and a “closed” state. The moveable sample tray 34 holds a sample holder 36 therein which can be placed into or removed from the moveable sample tray 34. The sample holder 36 is typically an optically transparent substrate or multiple optically transparent substrates that holds the nanometer or micrometer-sized objects and fluorescent labels. The sample holder 36 may also include a three-dimensional volume or container in some embodiments. The sample holder 36 may include a glass or plastic surface. In one aspect, the sample holder 36 is a single optically transparent substrate (e.g., glass cover slip) and samples are loaded onto the same and dried prior to imaging. In other embodiments, the sample holder 36 may sandwich a sample between multiple substrates. When the sample holder 36 is placed into the moveable sample tray 34 and the sample tray 34 is moved to the closed position, the sample holder 36 is then positioned within the optical path 20 for imaging.

The housing 30 includes a z-adjust stage 38 that is disposed in the housing 30 and moves the sample holder 36 (and sample tray 34) in the z-direction. The z-direction is illustrated in FIG. 1B and is aligned along the axis of the optical path 20. The z-adjust stage 38 moves a portion of the housing 30 relative to the camera 14. For example, in one embodiment, the z-adjust stage 38 moves the sample holder 36 and the light source 40 in the z-direction while other optical components such as the lens 46 described below remain stationary. As explained herein, the z-adjust stage 38 may be a dovetail translation stage (e.g., DT12, Thorlabs, Inc.) although other z-adjust stages 38 may be used. Adjustment of the stage is accomplished by rotation of a knob in either the clockwise or counter-clockwise direction to adjust the z distance. By adjusting the z-adjust stage 38 manually by the user, the focus of the optical system may be adjusted such that the fluorescent images can be focused. For example, by watching the display 22 of the mobile communication device 12, a user can adjust the z-adjust stage 38 to bring the nanometer or micrometer-sized objects into focus.

The housing 30 also includes a light source 40 that is secured to the housing and oriented at an angle relative to the sample holder 36. In one aspect of the invention, the light source is angled with respect to a normal intersecting with the surface of the sample holder 36 at an angle α as seen in FIG. 1E within the range of 20° to 95°. By having the light source 40 angled relative to the sample holder 36, this provides the advantageous benefit of reducing the transmission of scattered light to along the optical path 20 and into the camera 14 of the mobile communication device 12. In one preferred embodiment, the light source 40 is a laser diode although the light source 40 may also include a light-emitting diode (LED). The emitting wavelength of the laser diode is chosen based on the excitation wavelength(s) of the fluorescent labels used during the imaging process. By having a laser diode as the light source 40, a narrow-band of excitation radiation is produced.

In one aspect of the invention, the light source 40 may include a set of interchangeable light sources 40 wherein different light sources 40 having different emitting wavelengths may be used. For example, these may include different laser diodes or light emitting diodes that can be selectively interchangeable by securing the same to the housing 30. Alternatively, multiple different light sources 40 are locate in the housing 30 and different light sources 40 can be selectively turned on using, for example, switching circuitry.

The light source 40 is coupled to a power source 42 such as a battery or multiple batteries. The light source 40 may be mounted on or in thermal communication with a heat sink as the light source 40 may generate heat upon actuation. A switch 44 is provided so that the user can manually turn the light source 40 on and off as needed.

The housing 30 also includes one or more lenses 46 disposed therein and placed within the optical path 20. For example, multiple lenses 46 can be combined to form a single lens module. As seen in FIGS. 1B, 1C, and 1F, the at least one lens 46 is located beneath the sample holder 36. This lens 46 (or multiple lenses) is used to primarily focus fluorescent light that is emitted from the fluorescently labeled particles in the sample that is found on or within the sample holder 36. The lens 46 has a low numerical aperture (NA), for example, within the range of about 0.1 to about 0.9. In one aspect, the set of lenses 46 forms an adjustable numerical aperture (NA) system that has a NA within the range of about 0.1 to about 0.9. Adjustment may be accomplished by moving the lenses 46 of the system relative to one another along the optical path 20. While a majority of the excitation light from the light source 40 avoids the direction of travel along the optical path 20, there may be some scattered light from the light source 40 that enters the lens 40. The lens 46 in combination with the lens 16 of mobile communication device 12 creates 2× optical magnification.

To exclude this scattered light from the light source 40, the housing 30 includes a moveable filter tray 48 that moves between an “open” state and a “closed” state. The moveable filter tray 48 is dimensioned to hold therein an optical filter 50. The optical filter 50 is made of a material that substantially prevents the transmission of excitation light while at the same time allows the transmission of fluorescent light for imaging. In some embodiments, the excitation light emitted by the light source 40 has a shorter wavelength than the fluorescent light that is emitted from the fluorescent labels or probes. In this embodiment, the optical filter 50 may constructed as a long-pass (LP) filter whereby the longer wavelength light from the fluorescently labeled particles passes through the optical filter 50 while excitation light from the light source 40 is blocked. Alternatively, the optical filter 50 may be constructed as a band-pass filter. For example, in one embodiment, the optical filter 50 may be made from a thin-film interference filter media that can be placed in the moveable filter tray 48. After placing the optical filter 50 in the moveable filter tray 48 and closing the same, the optical filter 50 is positioned within the optical path 20 such that the optical filter 50 is interposed between the lens 46 in the housing 30 and the lens 16 in the mobile communication device 12. In one embodiment, a set of different optical filters 50 may be provided with the different optical filters 50 being interchangeable within the moveable filter tray 48. For example, different optical filters 50 may be used with specific light sources 40 and fluorescent probes, labels, for fluorophores.

FIG. 1F illustrates a schematic representation showing the ray tracing a result of the illumination with laser light from the light source 40. Excitation light from the laser light source 40 and scattered light from the light source 40 are illustrated in solid lines while fluorescent emission is illustrated in dashed lines. As seen in FIG. 1F, the optical filter 50 prevents any scattered light from the laser light source 40 from entering the lens 16 of the mobile communication device 12 thereby ensuring that the only light that reaches the image sensor 18 is fluorescent light.

To use the imaging device 10, a sample containing the particles (e.g., virus particles, beads, or the like) and the fluorescent labels or probes is placed on or in the sample holder 36. After the sample is allowed to dry, the sample holder 36 is inserted into the moveable sample tray 34 and the sample tray 34 is moved to the closed position. The housing 30 is then secured to the mobile communication device 12. Alternatively, the housing 30 may have already been secured to the mobile communication device 12 prior to loading of the sample. The light source 40 is turned on and the camera 14 of the mobile communication device is activated to capture images of the fluorescently labeled particles. The focus of the imaging device 10 may be adjusted by the user by adjusting the z-adjust stage 38.

One or more images of the fluorescently labeled particles may be taken and saved by the mobile communication device 12. In one aspect of the invention, software loaded on the mobile communication device 12 which may be in the form of an application or “app” which can be used to identify the imaged nanometer or micrometer-sized particles in the image. The software may also determine the brightness, shape, count, size, and/or identity (e.g., type or species) of the individual imaged particles or groups of particles may be grouped together in the image. The software may be able to calculate the load of the sample (e.g., viral load) based on the concentration of identified nanometer or micrometer-sized objects.

The raw image files and/or or post-processed information regarding the imaged sample can then be sent to a remote computer/server or the like using the communication functionality of the mobile communication device 12. In one aspect, post-processed information (e.g., images or results) regarding the same may be returned to the mobile communication device 12 or they may be shared with another user or users. This information may be sent over a proprietary network (e.g., a telecommunications network) or over a wide area network (e.g., the Internet). Note that in one aspect of the invention, components of the imaging device 10 may be sold as part of a kit that includes, for example, the sample holder 36, optical filter(s) 50, and reagents for sample preparation (e.g., antibodies, fluorescent labels, and the like). The kit could be used with the user's own mobile communication device 12 although in some embodiments, the mobile communication device 12 may also be offered as part of a kit. The kit may also provide directions to download the associated software or “app” that may be used in conjunction with the imaging device 10.

### Experimental

### Handheld Fluorescence Microscopy on a Mobile Phone

A field-portable, mechanically robust and functional opto-mechanical attachment (e.g., housing) was developed that secured to the existing camera module of a smart-phone. The housing integrates multiple components such as the excitation light source, power unit, sample holder, focusing stage, and imaging optics including e.g., an external lens (focal distance, f₁=4 mm) and a thin-film interference based LP filter (illustrated in FIGS. 1A-1D).

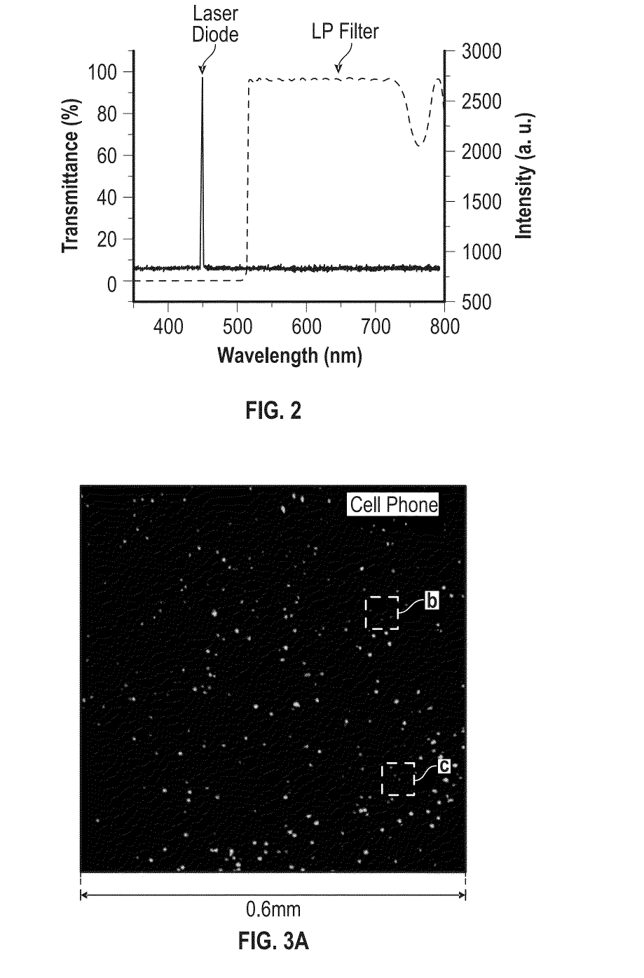

Some of the major challenges for field-portable imaging of individual nanoscale fluorescent particles/objects on a mobile phone microscopy platform are related to the weak fluorescent signal arising from such small-scale objects in addition to the noise background created by the excitation light leakage and detection noise. To overcome some of these signal-to-noise ratio (SNR) related limitations, a high-power compact laser diode (75 mW) was installed as the excitation source to illuminate the sample plane with a rather high incidence angle of e.g., ˜75° (e.g., α˜75°). Of course, other angles may also be used, for example, an angle within the range of 20° to 95°. This oblique illumination angle is important to reduce the background noise in the fluorescent images as also illustrated in the ray-tracing illustration of the mobile phone-based fluorescence microscope (FIG. 1F). The directly transmitted excitation light is missed by the low NA detection optics, except for the scattered photons that are mapped onto the mobile phone sensor-array (solid rays). To further clean the background noise and get rid of such scattered excitation photons, employed a thin-film based LP filter was employed with a blocking wavelength of 500 nm and a sharp transmission slope which strongly attenuates shorter wavelengths, such as the scattered excitation light (FIG. 2). This combination of high-angle excitation illumination and high-performance LP filter enabled the device to achieve very high contrast on the mobile phone microscope that is required for imaging of isolated fluorescent nanoparticles and viruses.

During imaging experiments, air-dried samples (fluorescent particles or fixed viruses) were supported by a cover glass (18×18 mm, 150 μm thickness) and were held by a movable sample tray that is inserted to the mobile phone opto-mechanical attachment housing from the side (FIG. 1D). Liquid samples can also be imaged on the same mobile phone imaging platform using disposable micro-fluidic devices or simply between two cover slips or glass slides that are sealed. The sample chamber and the laser source are integrated on an adjustable platform which is coupled to a miniature dovetail stage for focus adjustment along the z direction. This opto-mechanical attachment (i.e., housing) also serves as a light-shield unit which protects the users from exposure to the excitation laser (75 mW) and permits highly sensitive fluorescence imaging experiments to be conducted even in the presence of strong ambient light.

Single Nanoparticle Imaging Experiments.

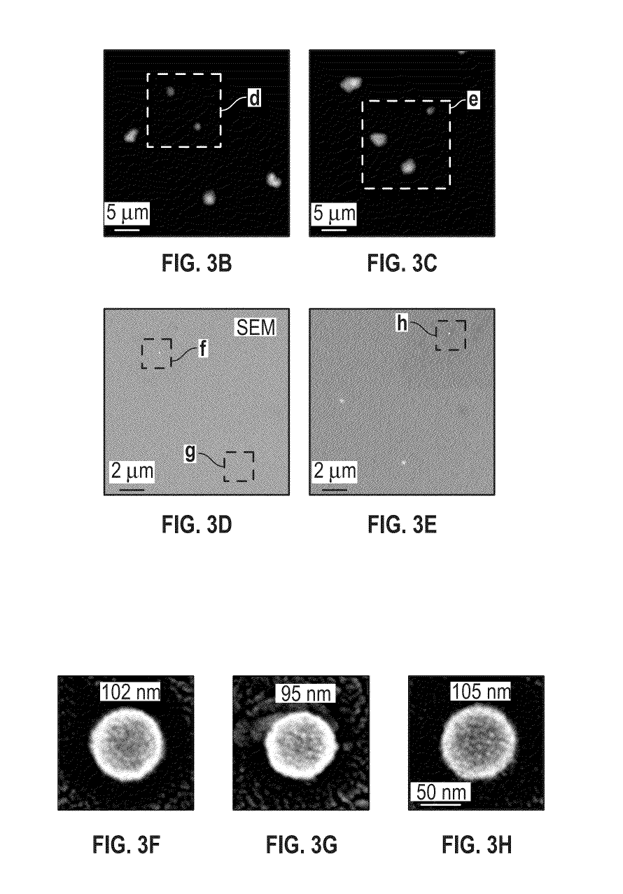

The performance of the mobile phone imaging device was first tested by imaging fluorescent polystyrene (PS) beads with different sizes (ranging from 10 μm down to 100 nm). FIG. 3A illustrates a typical fluorescence image of 100 nm fluorescent particles obtained by the mobile phone-based imaging device with an exposure time of 0.5 s. Two representative regions of interests (ROIs) are also highlighted by dashed white boxes and enlarged in FIGS. 3B and 3C, respectively. The brighter and bigger spots in these images are attributed to the clustering of nanoparticles, whereas single 100 nm particles appear to be weaker and smaller as shown in the dashed boxes in FIGS. 3B and 3C. The detection of isolated 100 nm particles on the mobile phone imaging device was independently validated by imaging the same regions of the samples with SEM. FIGS. 3D and 3E illustrate SEM images that correspond to the same ROIs within the dashed boxes in FIGS. 3B and 3C, respectively. Three individual nanoparticles are shown in solid boxes (FIGS. 3D and 3E), and higher magnification SEM images indicate that the sizes of these particles are 102 nm, 95 nm, and 105 nm, respectively (FIGS. 3F, 3G, 3H).

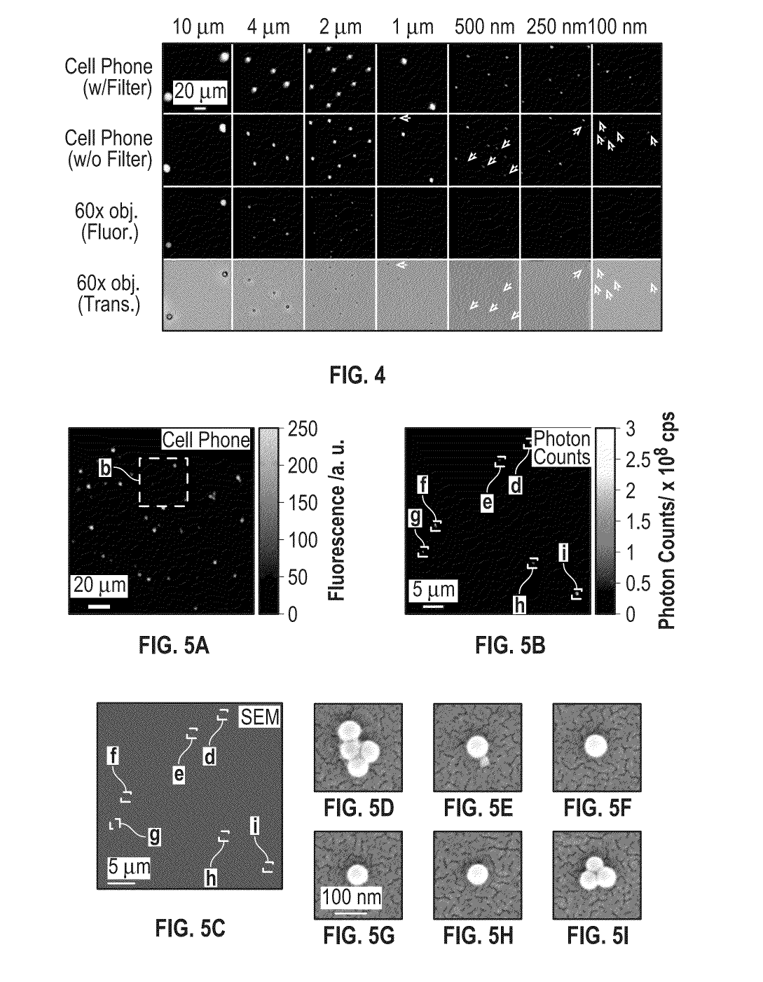

Further validation was obtained that the detected signals on the mobile phone images were indeed due to fluorescence (but not due to scattering of excitation light) by mixing non-fluorescent PS particles with fluorescent samples of comparable sizes, and imaging the mixture of these particles both with (w/) and without (w/o) the LP emission filter. Specifically, 1-μm fluorescent particles were mixed with 1-μm non-fluorescent particles, and 500 nm, 250 nm, and 100 nm fluorescent particles were mixed with 500 nm non-fluorescent particles. The color of the fluorescent nanoparticles imaged on the mobile phone imaging device was green when the emission filter was used, and it turned to blue immediately after removal of the emission filter (1^{st} and 2^{nd} rows in FIG. 4). Through these experiments it was confirmed that the non-fluorescent particles in these mixtures (see the arrows in FIG. 4) do not appear in the mobile phone-based images when the LP emission filter is used, clearly indicating that the detected signals on the mobile phone images were due to fluorescent emission, but not a result of scattering related leakage of the excitation beam.

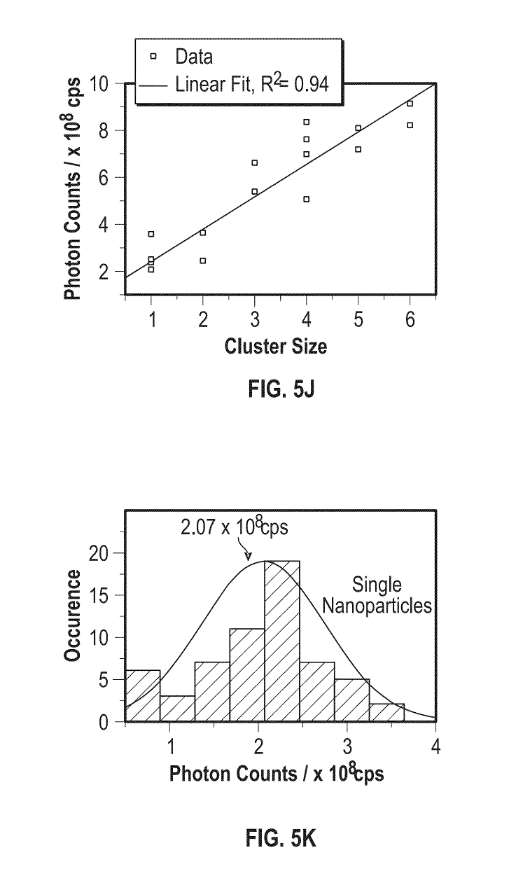

The brightness of 100 nm fluorescent particles that were imaged using the mobile phone-based imaging device was also characterized by a conventional confocal microscopy set-up that is equipped with a hybrid photon-counting detector. To correlate the brightness of the fluorescence signal with the cluster size (n) of the fluorescent nanoparticles, the same sample of interest was imaged by the mobile phone-based imaging device (FIG. 5A), the photon-counting confocal microscope (FIG. 5B), and an SEM (FIGS. 5C and 5D-5I), sequentially. The mobile phone-based imaging device image depicts a heterogeneous distribution of fluorescence intensity which can be attributed to the formation of different sized nanoparticle clusters (FIG. 5A). The photon-counting map shown in FIG. 5B for the same sample illustrates a brightness distribution (expressed in photon counts per second, or cps) that matches very well to the mobile phone-based imaging device results. The formation of nanoparticle clusters as well as the relationship between cluster size (n) and the brightness of signal was further validated by SEM. FIG. 5C shows an SEM image of the same region as in FIG. 5B and the dashed white square of FIG. 5A. Higher magnification SEM images (FIGS. 5D-5I) reveal that four of these particles are single 100 nm particles (n=1, FIGS. 5E-5H), one is a tetramer (n=4, FIG. 5D), and one is a trimer (n=3, FIG. 5I). As expected, the nanoparticle clusters (n≧2, e.g. FIGS. 5D and 5I) are brighter than the individual nanoparticles (n=1, e.g. FIGS. 5E-5H) as also validated in both the mobile phone-based fluorescence image (dashed region of FIG. 5A) and the photon-counting map (FIG. 5B). Quantitatively, the photon count per second for fluorescent nanoparticles is found to be linearly proportional to the size of the clusters with a fitting coefficient of 0.94 (see FIG. 5J). For single 100 nm particles only, a brightness distribution is also shown in FIG. 5K, revealing a mean fluorescent photon count of 2.07×10⁸ cps. Previous studies have reported that a single fluorophore such as fluorescein or Alexa Fluor® 488 exhibited a fluorescence emission rate on the order of 10⁵ cps. This suggests that there are approximately a few thousand fluorescein molecules embedded in a single 100 nm PS particle. However, note that the excitation and photon collection conditions in different experimental set-ups vary, which means the absolute photon count per second (cps) per particle might differ between different imaging systems.

In the mobile phone-based imaging device, isolated 100 nm fluorescent particles can be readily detected over an area of 0.6 mm×0.6 mm (FIG. 3A), which, however, is smaller than the full FOV of the imaging platform (i.e., ˜3 mm×3 mm). This relative reduction in the imaging FOV is due to the small spot size of the excitation laser beam (˜1.8 mm in diameter) as well as the aberrations of the low NA imaging optics installed on the mobile phone-based imaging device. A measurement of the two-dimensional (2D) laser illumination profile on the sample plane shows that the excitation intensity drops rapidly at a distance that is larger than 0.3 mm away from the center of the illumination area. As a result of this, 100 nm fluorescent particles located outside of this 0.6-mm wide region are not excited efficiently. However, for larger sized objects which have stronger fluorescence emission and are less sensitive to imaging and focusing conditions, the object FOV can be significantly larger, reaching the entire 3 mm×3 mm.

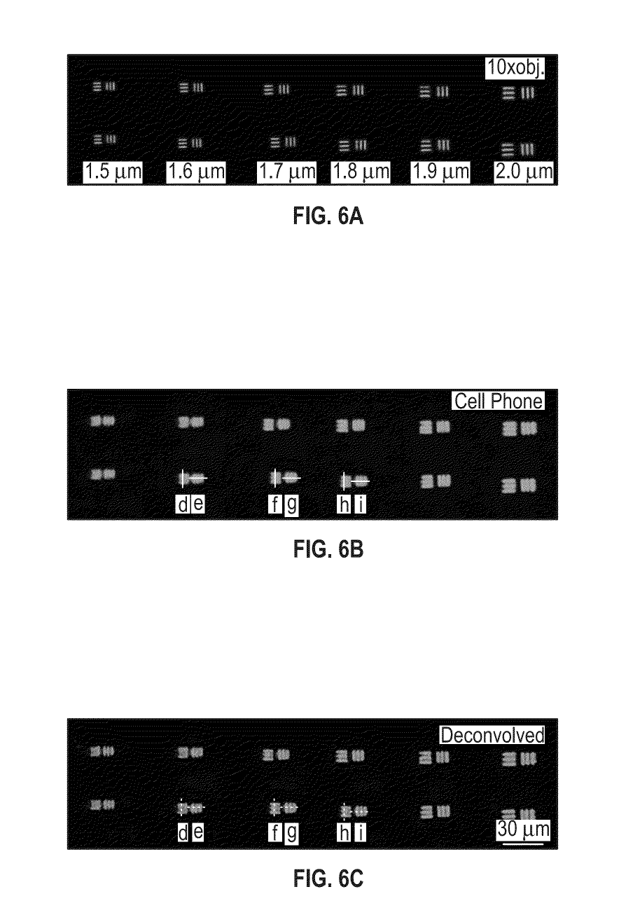

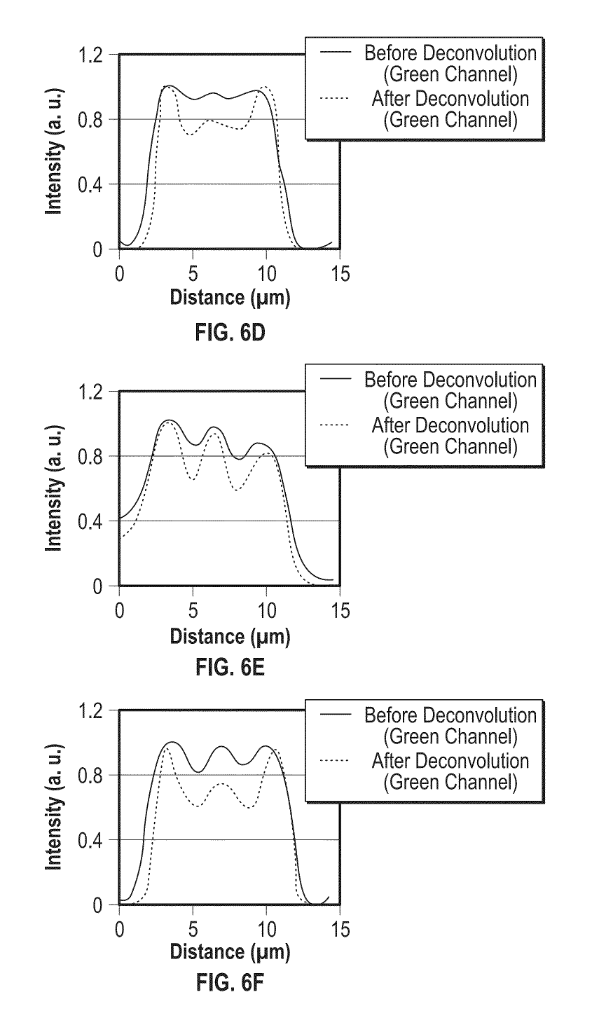

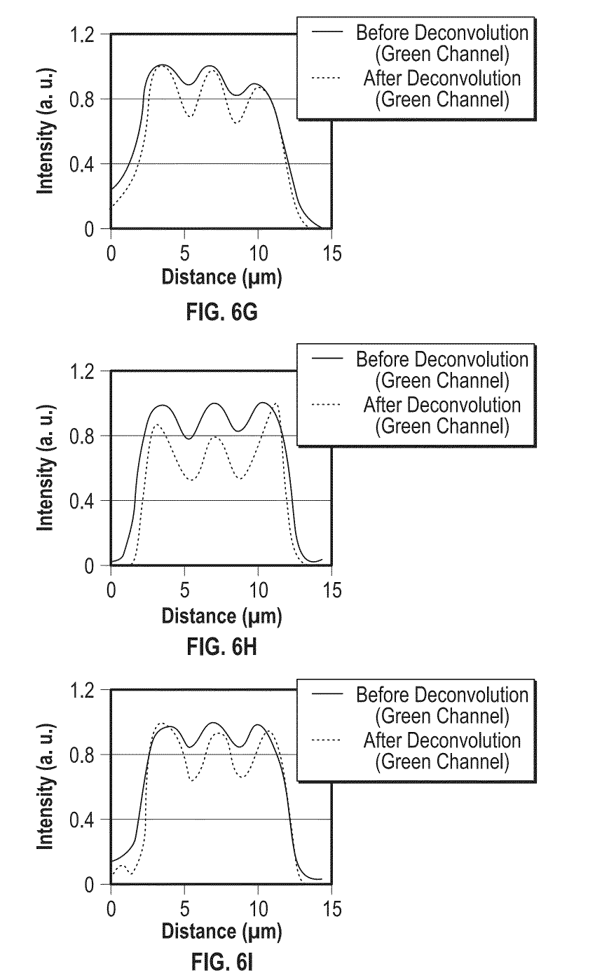

The spatial resolution of the mobile phone-based imaging device was also characterized using a resolution test target fabricated by etching a 200 nm thin gold-chromium (Au/Cr) film on a glass slide via e-beam lithography. This resolution target consists of various line patterns which have equal line widths and gap distances (ranging from 1.5 μm to 2.0 μm). FIGS. 6A and 6B show the transmission images of this resolution test target acquired by a conventional microscope (FIG. 6A; 10× objective lens, 0.25 NA) and the mobile phone-based imaging device (FIG. 6B), respectively. To mimic the fluorescence experiments, the illumination wavelength for these resolution tests was set to green (520 nm). FIG. 6C depicts a deconvolved mobile phone-based image based on the Lucy-Richardson deconvolution algorithm and a 2D point spread function (PSF) that is estimated using isolated 100 nm fluorescent particles. Line intensity profiles of 1.6-μm, 1.7-μm, and 1.8-μm bars before (solid curves) and after deconvolution (dashed curves) are shown in FIGS. 6D-6I. Even before Lucy-Richardson deconvolution is applied, the mobile phone-based imaging device was able to resolve 1.7-μm bars along both the horizontal and vertical directions, as well as 1.5-μm bars along the horizontal direction (FIGS. 6D-6G). After deconvolution, 1.6-μm bars along the vertical direction (FIG. 6D) and 1.5-μm bars along the horizontal direction were better resolved.

Single Virus Imaging Experiments.

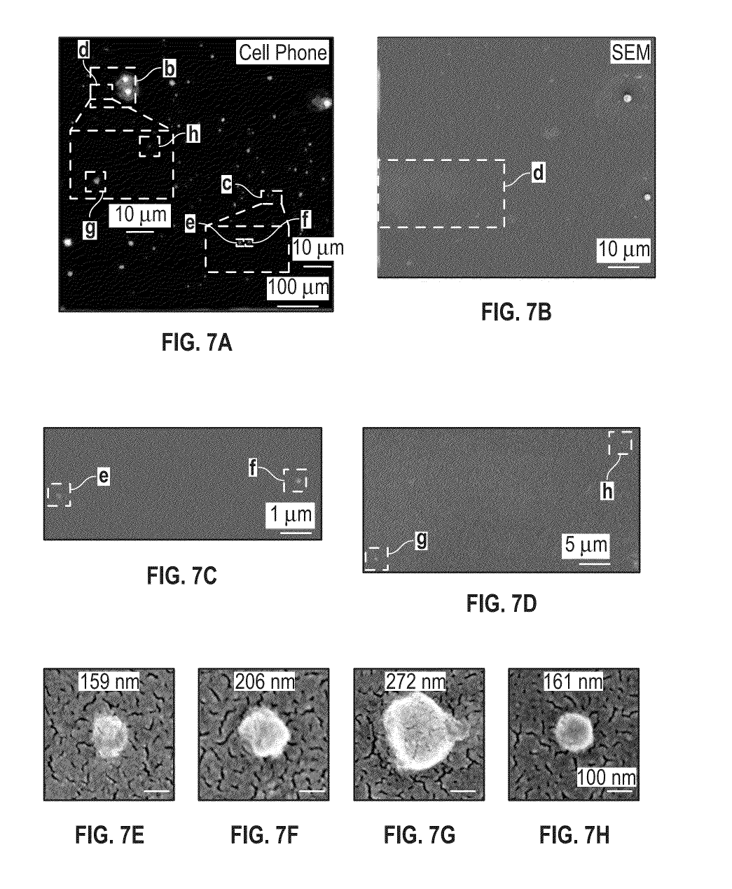

To further demonstrate the imaging performance of mobile phone-based imaging device, individual HCMV particles were also imaged. HCMV is a member of the herpes virus family that causes severe mortality especially in immunocompromised patients. It is also one of the leading causes of virus-associated birth defects, such as mental retardation and deafness. The HCMV virus particle consists of genome, capsid, tegument, and a lipid bilayer envelope with an overall particle size ranging from 150 nm to 300 nm in diameter. To label intact HCMV particles, the glycoprotein B (gB) molecule was targeted which is one of the most abundant glycoproteins on the virus envelope with anti-gB primary antibody, and then labeled the virions with Alexa Fluor® 488-conjugated secondary antibody as described in the Methods Section herein. Conventional fluorescence microscopy confirmed the successful fluorescent labeling of HCMVs on glass slides, whereas control samples containing only primary and secondary antibodies did not show significant fluorescent backgrounds. For the detection of single viruses using the mobile phone-based imaging device, fluorescence images of labeled HCMV samples were acquired under similar imaging conditions as fluorescent nanoparticles. A representative fluorescent image of labeled HCMV particles obtained from the mobile phone imaging device is shown in FIG. 7A, where red-fluorescent PS beads (2 μm in diameter) were added to provide location markers for SEM comparison, as also detailed in the Methods Section. Two different ROIs containing isolated viral particles are highlighted with the dashed boxes as well as the insets in FIG. 7A, and their corresponding SEM images are also shown in FIGS. 7B and 7C, respectively. FIG. 7D is an enlarged SEM image taken from the dashed area or region “d” in FIG. 7B. The fluorescent dots highlighted by the dashed boxes and the insets in FIG. 7A were thus confirmed by the high-magnification SEM images to be single virus particles as shown in FIGS. 7E-7H. According to SEM measurements, the size of each HCMV particle varied between 159 nm and 272 nm, which provide a good match to the previous reports on HCMV.

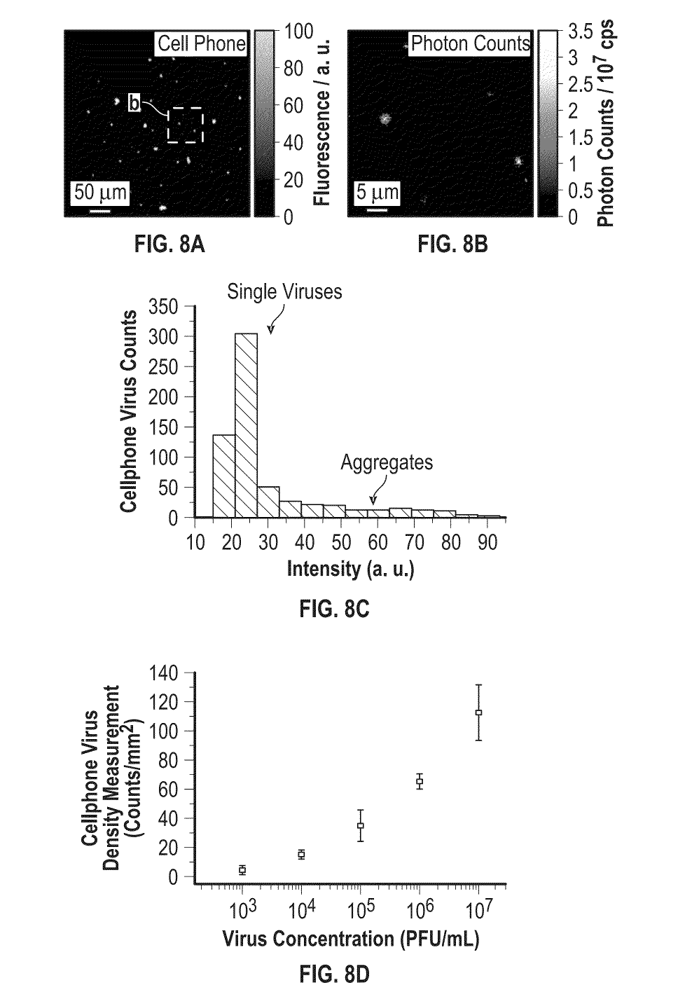

The detection of single fluorescently labeled virus particles is challenging due to the low fluorophore labeling density per virus particle (FIG. 8A). Photon counting analysis suggests that the brightness of labeled HCMV particles is approximately an order of magnitude weaker (10⁷ cps, FIG. 8B) than that of individual 100 nm fluorescent particles (10⁸ cps, FIG. 5B). This implies that a labeling density on the order of a few hundred fluorophores per virus particle was achieved via the surface marker labeling strategy. The fluorescence signal of labeled virus particles detected using the mobile phone-based imaging device also displayed a broad distribution as revealed by single-particle analysis shown in FIG. 8C. The major peak at low-intensity region (a.u. <˜30) can be attributed to isolated virus particles, whereas the distribution with higher fluorescent intensities are due to virus aggregates (FIG. 8C). The density of virus particles (counts/mm²) was also measured using the mobile phone images which, as desired, exhibited a strong dependence on the initial incubation concentration (PFU/mL) of virus solutions (FIG. 8D). The control sample (without any virus particles but only treated with primary and secondary antibodies) displayed an averaged fluorescent spot density of 12.7±0.8 counts/mm². After subtracting this background value, the samples incubated with 10³, 10⁴, 10⁵, 10⁶, and 10⁷ PFU/mL of HCMV particles yielded mobile phone-based viral density measurements of 3.9±2.9, 14.9±3.0, 34.2±10.2, 65.2±5.2, and 112.3±19.2 counts/mm², respectively (FIG. 8D), which demonstrates the correlation between the mobile phone-based virus density measurements (i.e., counts/mm²) and the initial incubation concentration of the viral load (i.e., PFU/mL).

Methods

Opto-Mechanical Design of the Mobile Phone Imaging Device Housing Attachment.

The three-dimensional (3D) opto-mechanical attachment (i.e., housing) to mobile phone (PureView 808, Nokia) was designed using Inventor software (Autodesk) and built by a 3D printer (Elite, Dimension). A compact blue laser diode (obtained from eBay) was mounted on a 12×30 mm copper module (also used as a heat-sink) was used as the excitation light source and powered by three AAA batteries. The laser diode provides a narrow-band excitation centered at 450 nm (FWHM=2 nm) with a total output power of ˜75 mW. The spectrum and optical power of this laser diode were measured by HR2000+ spectrometer (Ocean Optics) and PM100 optical power meter (Thorlabs), respectively. The sample slide of interest was illuminated by this blue laser diode with a 75° incidence angle and its position was controlled using a miniature dovetail stage (DT12, Thorlabs) for focus adjustment. The fluorescence emission from the specimen was collected by an external lens (f₁=4 mm) and was separated from the excitation light by using a 2-mm thick 500 nm long-pass thin-film interference filter (FF01-500/LP-23.3-D, Semrock) that was positioned after the sample (as seen in FIG. 1F). Magnified fluorescent images of the specimen were formed using both the external lens and the built-in lens (f₂=8 mm) of the mobile phone camera, and were recorded by the CMOS sensor chip (7728×5386 pixels, pixel size=1.4 μm) embedded on the mobile phone.

Preparation of the Fluorescent Particle Samples.

Green fluorescent polystyrene (PS) particles (excitation/emission: 505/515 nm) with various sizes (0.1, 0.25, 0.5, 1, 2, 4, and 10 μm) were obtained from Invitrogen. For imaging isolated particles, the samples were diluted 10⁴-10⁵ times in deionized (DI) water as the diluent. Glass cover slips (18×18 mm, No. 1, Thermo Fisher) were rinsed sequentially with acetone, isopropanol, methanol and DI water, and dried by nitrogen blow. Cleaned cover slips were further treated by plasma (BD-10AS, Electro-Technic Products, Inc.) for a duration of 5-10 s to hydrophilize the surface. Finally, 2 μL of diluted solution was pipetted onto the treated glass cover slips and dried at room temperature (RT) before imaging.

Fluorescent Labeling of Human Cytomegaloviruses (HCMVs).

For immobilization of HCMV particles, glass cover slips (9×9 mm, No. 1, Electron Microscopy Sciences) were washed and dried as previously described. The surface of each glass substrate was functionalized with amino groups by immersion in 2% (v/v) solution of 3-aminopropyltriethoxysilane (Sigma) in acetone for 10 min at RT. Coated slides were rinsed thoroughly with acetone and DI water and allowed to dry in nitrogen blow. 250 μL of cell-culture supernatant containing HCMV viruses at various concentrations ranging from 10³ to 10⁷ plaque forming units per mL (PFU/mL) was seeded onto each amine-functionalized glass slide in a 24-well plate for overnight. The culture medium was then removed and the virus particles were fixed and immobilized onto glass substrates by treating with cross-linking buffer containing 2% paraformaldehyde (Sigma) and 0.1% glutaraldehyde (Sigma) in phosphate buffered saline (PBS) for 2 hrs. Excess cross linkers were quenched by tris buffered saline (TBS, 500 mM tris) for 30 mins. These substrates were then blocked from non-specific protein-protein interactions using the blocking buffer containing 3% bovine serum albumin (BSA), 10% fetal bovine serum (FBS), and 0.1% TritonX-100 in TBS for 1 hr. The glass slides that contained immobilized viral particles were then washed with TBS (50 mM tris) for three times and followed by incubation with mouse monoclonal antibody (CH446, Virusys Corp) against HCMV glycoprotein B at 10 μg/mL for 1 hr. Unbound antibodies were removed by washing three times with TBS (50 mM tris). The sample slides were further incubated with 2 μg/mL of Alexa Fluor® 488-conjugated secondary antibody against mouse IgG for 1 hr and washed three times with TBS (50 mM tris) buffer. Finally, the labeled virus slides were dried by nitrogen blow. On each slide, to provide location markers 2-μm-diameter red fluorescent PS particles were added (excitation/emission: 580/605 nm; from Invitrogen) which helped to better define regions of interest (ROIs) and search for the specific locations that contain isolated viral particles within our large field of view so that a comparison can be made between the mobile phone-based fluorescent images and the SEM images.

Photon Counting Microscopy.

The brightness of 100 nm fluorescent particles and Alexa Fluor® 488-labeled HCMV virus particles were independently characterized by using a confocal laser scanning microscope (TCS SP8, Leica) equipped with a high NA objective (HCX PL APO CS 63x/1.40 OIL) and a hybrid detector (HyD, Leica) that is capable of recording photon streams. Photon counting maps (512×512 pixels) were collected using 488 nm laser excitation and a 510-560 nm band pass emission filter. The laser beam was scanned at a rate of 1.2 μs/pixel with 8 accumulated scanning per line, resulting in an effective pixel dwell time of 9.6 μs/pixel.

SEM Comparison Experiments.

An FEI Nova 600 instrument operating at 10 kV was used to validate the size of individual nanoparticles or viruses imaged on the mobile phone-based imaging device. After imaging with the mobile phone-based imager, all the sample slides were sputtered with gold conductive layer for 60 s before SEM imaging experiments were performed.

While embodiments have been shown and described, various modifications may be made without departing from the scope of the inventive concepts disclosed herein. The invention(s), therefore, should not be limited, except to the following claims, and their equivalents.

1. An imaging device comprising:
a mobile communication device having a camera therein comprising an image sensor and a first lens contained in the mobile communication device;
a housing configured to be removably secured to the mobile communication device, the housing comprising:
a sample holder configured to hold a sample and aligned along an optical path intersecting with the image sensor and the first lens;
one or more second set of lenses disposed in the housing and aligned along the optical path;
a light source disposed in the housing and oriented to illuminate the sample holder at an angle relative thereto;
an optical filter disposed in the housing and aligned along the optical path, the optical filter interposed between the first lens and the one or more second set of lenses; and
a z-adjust stage disposed in the housing and coupled to the sample holder, the z-adjust stage configured to adjust the position of the sample holder in a z direction along the optical path.

2. The imaging device of claim 1, wherein the light source comprises a laser diode or a light-emitting diode.

3. The imaging device of claim 1, wherein the light sources comprises a set of interchangeable light sources.

4. The imaging device of claim 1, wherein the housing further comprises a switchable power source configured to power the light source.

5. The imaging device of claim 1, wherein the sample holder comprises an optically transparent slide.

6. The imaging device of claim 1, wherein the one or more second set of lenses comprises an adjustable numerical aperture (NA) lens system having an NA within the range of about 0.1 to about 0.9.

7. The imaging device of claim 1, wherein the filter comprises a band-pass or long pass filter that substantially blocks transmission of scattered light from the light source yet transmits fluorescent light emitted from a sample on the sample holder.

8. The imaging device of claim 1, wherein the filter comprises one of a set of interchangeable filters.

9. The imaging device of claim 1, wherein the light source is angled with respect to the sample holder at an angle within the range of 20° to 95°.

10. The imaging device of claim 1, wherein the housing comprises a moveable sample tray configured to hold the sample holder, wherein moveable sample tray positions the sample holder in the optical path when the moveable sample tray is moved to a closed position.

11. The imaging device of claim 1, wherein the housing comprises a moveable filter tray configured to hold the optical filter, wherein the moveable filter tray positions the optical filter in the optical path when the moveable filter tray is moved to a closed position.

12. A method of obtaining fluorescent images of a sample using the imaging device of claim 1 comprising:
loading the sample holder with a sample containing nanometer or micrometer-sized objects and fluorescent label;
illuminating the sample with the light source to cause the fluorescent label to emit fluorescent light; and
imaging the sample with the camera.

13. The method of claim 12, wherein the fluorescent label is specific to the nanometer or micrometer-sized objects.

14. The method of claim 13, wherein the nanometer or micrometer-sized objects comprises one or more of particles, cells, pathogens, and viruses.

15. The method of claim 12, further comprising adjusting the position of the sample holder in the z direction with the z-adjust stage.

16. The method of claim 12, further comprising transmitting an image obtained from the camera to a remote computer or processor.

17. The method of claim 12, wherein loading of the sample comprises diluting the sample with a diluent.

18. The method of claim 12, wherein the sample comprises particles having a size at or below 500 nm.

19. The method of claim 12, further comprising measuring at least one of the brightness, size, shape, count, or species of the nanometer or micrometer-sized objects in the image.
